(19) United States
(12) Patent Application Publication
(10) Pub. No.: US 2016/0311031 A1
(43) Pub. Date: Oct. 27, 2016

(54) THROUGH COOLANT MACHINE TOOL HAVING ANTI-VIBRATION SYSTEM

(71) Applicant: ENRICO R. GIANNETTI, East Bernard, TX (US)

(72) Inventor: ENRICO R. GIANNETTI, East Bernard, TX (US)

(21) Appl. No.: 14/694,584

(22) Filed: Apr. 23, 2015

(51) Int. Cl. B23B 29/02

(52) U.S. Cl. CPC B23B 29/022; B23B 2250/16; B23B 2250/12; B23B 2260/004

(57) ABSTRACT

A vibration dampening through coolant tool holder for machining operations, has an internal chamber within which a vibration dampening mass member is supported by resilient buffer members. The vibration dampening mass member has inner and outer tubular members that define a particulate chamber therebetween. A quantity of dense particulate such as granular tungsten carbide is located within the particulate chamber, causing the vibration dampening mass member to have sufficient mass to dampen the resonate frequency of vibration of said tool holder during machining activity. A vibration adjusting piston, actuated by an adjustment mechanism is linearly moveable with the tool holder and has dampening adjustment engagement with the mass member.

### BACKGROUND OF THE INVENTION

1. Field of the Invention

The present invention relates generally to machine tools or tool holders for metal cutting and working machines. More particularly the present invention concerns tool holders including boring bars, threading tools and the like, which because of their length and flexibility are often subject to significant vibration during rotary machining operations. This invention also concerns machine tools that have a through-coolant capability for conducting a flow of pressurized coolant fluid through internal passages of a machine tool and emitting the coolant as a jet or spray that is directed to the cutting interface of a cutting insert with rotating metal stock for cooling and for removal of metal chips that have been cut from the rotating stock.

2. Description of the Prior Art

Machining vibration, typically referred to as “chatter”, especially when relatively long and somewhat flexible machine tools such as boring bars are used, interferes with optimum machining activity and usually results in roughly machined surfaces and noisy machining operations when machining internal and external surfaces, threads and the like within or on metal stock that is rotated by a machining system. Numerous attempts have been made over an extensive period of time to achieve tuning of boring bars and other such machine tools to cancel the resonant frequency of the machine tools and thus minimize the vibration or chatter that interferes with optimum metal cutting operations such as boring,

threading and cutting.

Tool holders such as boring bars have been developed, as set forth in U.S. Pat. No. 3,774,730, that incorporate a dynamic vibration absorber having the capability for being dynamically tuned to dampen the rotary machining vibration that causes tool chatter resulting in rough and noisy machining during rotary metal working activity. U.S. Pat. No. 6,443,673 discloses a tunable tool holder has an absorber mass that is supported within a vibration dampening chamber between elastomer supports and employs a moveable and adjustable pressure plate for compressing the elastomer supports and dynamically tuning the tool holder to minimize the vibration or chatter that occurs during machining activity. Applicant's pending patent application Ser. No. 14/481,758 entitled Machine Tool Having, Anti-Vibration Tuning Mechanism For Chatter Minimized Machining, employs a micrometer type tuning mechanism for controlled adjustment of machine tools such as boring, grooving or threading bars to achieve substantially vibration free machining. Applicant's machine tool also has a through-coolant design to provide for the flow of coolant fluid through the machine tool to a cutter support head for continuous cooling of the cutting interface of a replaceable machining insert that is supported by the cutter support head.

Each of the anti-vibration machine tools known to applicant employ a vibration absorbing mass that is composed of a very dense solid material, such as tungsten carbide, that is machined or otherwise formed to define a desired geometry and weight to be received and supported within an internal chamber of an anti-vibration machine tool. Being composed of a very expensive material such as tungsten carbide, the anti-vibration mass typically constitutes approximately half the cost of the entire anti-vibration machine tool. Moreover, if slight adjustment of the dimension or geometry of the anti-vibration mass should become necessary, the expensive anti-vibration mass will typically need to be discarded since its physical dimensions cannot typically be changed and the mass of an anti-vibration machine tool will not fit properly within the mass containing chamber of a redesigned machine tool having a different internal chamber geometry. This potential expensive waste problem inhibits the commercial viability of manufacturing and selling anti-vibration machine tools.

### SUMMARY OF THE INVENTION

It is a principal feature of the present invention to provide an anti-vibration or vibration dampened machine tool having a mass containing chamber and having a granular mass composed of dense particulate, such as granular tungsten carbide for example, that substantially fills the mass containing chamber and provides anti-vibration or vibration dampened machining characteristics to minimize tool chatter during machining, resulting in precision machining on or within a workpiece. The dense vibration dampening particulate is recoverable in the event the machine tool becomes sufficiently worn or damaged that its use cannot be continued. This recovered particulate does not become degraded during use of a tool and may be used in the mass containing chamber of other machine tools, regardless of the size of the tool,

It is another feature of the present invention to provide a novel vibration dampened machine tool having a dense granular vibration dampening mass for supporting a replaceable cutter and having the capability of being tuned by adjustment to minimize tool chatter during machining;

It is also a feature of the present invention to provide a novel machine tool having an internal vibration absorbing mass composed of dense granular material for minimizing the presence of tool chatter or vibration during machining and having a tuning mechanism that is selectively adjustable by a machinist to essentially absorb or cancel the resonant frequency of the tool as needed to provide for smooth and efficient cutting of precision metal surfaces on a rotating work-piece.

It is another feature of the present invention of provide a novel adjustable vibration dampened machine tool having an internal fluid flow passage through which coolant fluid is pumped through the machine tool and is emitted as a jet from a jet port in a cutter support head and is applied to the cutting interface of the replaceable cutter member with the work-piece being machined.

Briefly, the various objects and features of the present invention are realized through the provision of an elongate machine tool holder mechanism having a cutter support head to which a replaceable cutter insert is secured for machining. The cutter support head is preferably provided with a coolant jet fitting that is in communication with the fluid supply passage of the tool and is arranged to direct a jet of coolant fluid onto the cutting edge of a cutter insert as it is in cutting engagement with a moving work piece being rotated or otherwise moved by a machining system. The machine tool defines an elongate internal chamber within which is located a vibration absorbing or dampening mass member having an internal particulate chamber containing a quantity that is composed of a dense granular material, such as tungsten carbide, or any other material having a rather high density, such as a density substantially equaling or exceeding the density of iron and steel. The granular vibration absorbing mass is encapsulated within the elongate internal vibration dampening chamber of a mass containing tubular housing by annular vibration dampening and centering members that are positioned about end flanges that define portions of the tubular housing. This feature causes the external surface of its tubular housing of the vibration dampening mass to be supported in spaced relation with the internal surface of the elongate internal chamber and internal components of the machine tool. An internal particulate containment wall structure of the mass containing tubular housing is formed by a tubular member that defines a flow passage for coolant flow through the tool to the cutter support head and serves to isolate the dense granular material of the vibration dampening mass from any contact with the coolant fluid.

According to an embodiment of the present invention a machine tool holder, such as a boring bar, internal threading tool, internal grooving tool or the like is provided with an anti-vibration tuning mechanism in the general form of a micrometer type rotary adjustment mechanism that is manually operated from the rear end portion of an elongate shank of the machine tool holder. The micrometer type rotary adjustment mechanism is rotated in either selected rotational direction to cause inward or outward linear movement of a force applying vibration tuning piston member. This inward or outward linear piston movement alters the vibration adjusting force that is applied by the tuning piston to the rearmost elastomer dampening and mass positioning element of a dampening mechanism for anti-vibration adjustment or tuning to substantially eliminate machine tool vibration and chattering during machining.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is an isometric illustration showing a machine tool holder which may have the form of a through-coolant boring bar, internal threading or grooving tool or the like that embodies the principles of the present invention;

FIG. 2 is a longitudinal section view showing the forward or metal cutting end portion of the through-coolant vibration dampening machine tool holder of FIG. 1, showing the structure for containment and support of the granular mass of dense particulate and for flow of coolant fluid through the tool and showing other internal components thereof in detail;

FIG. 3 is a longitudinal section view showing the rear or machine tool supported end portion of the through-coolant machine tool holder of FIG. 1, showing the coolant fluid inlet and the vibration dampening adjustment mechanism thereof in detail;

FIG. 4 is an enlarged partial longitudinal sectional view showing the relationship of one of the ring type resilient members for centralizing and cushioning the housing that contains the anti-vibration mass within the tubular body of the tool metal cutting machine tool:

FIG. 5 is a longitudinal section view showing the housing structure of the vibration dampening metal working tool of the present invention;

FIG. 6 is a longitudinal section view of the left end flange anti-vibration tuning mechanism of the machine tool holder;

FIG. 7 is a longitudinal section view showing the connecting tube for conducting the flow of coolant fluid through the vibration dampening machine tool of the present invention;

FIG. 8 is a longitudinal section view showing the end flange member of FIG. 2 in greater detail;

FIG. 9 is a longitudinal section view showing a closure plug member which is normally threaded into a dense granular material fill port of the end flange member of FIG. 11.

FIG. 10 is a longitudinal section view showing the forward or cutter insert support end of the vibration dampening machine tool, together with the coolant flow mechanism thereof;

FIG. 11 is a longitudinal section view showing the configuration of the granular vibration dampening mass of FIG. 5; and

FIG. 12 is a partial longitudinal section view, showing a resilient ring type cushioning member in relation to the vibration dampening mass;

### DETAILED DESCRIPTION OF PREFERRED EMBODIMENT

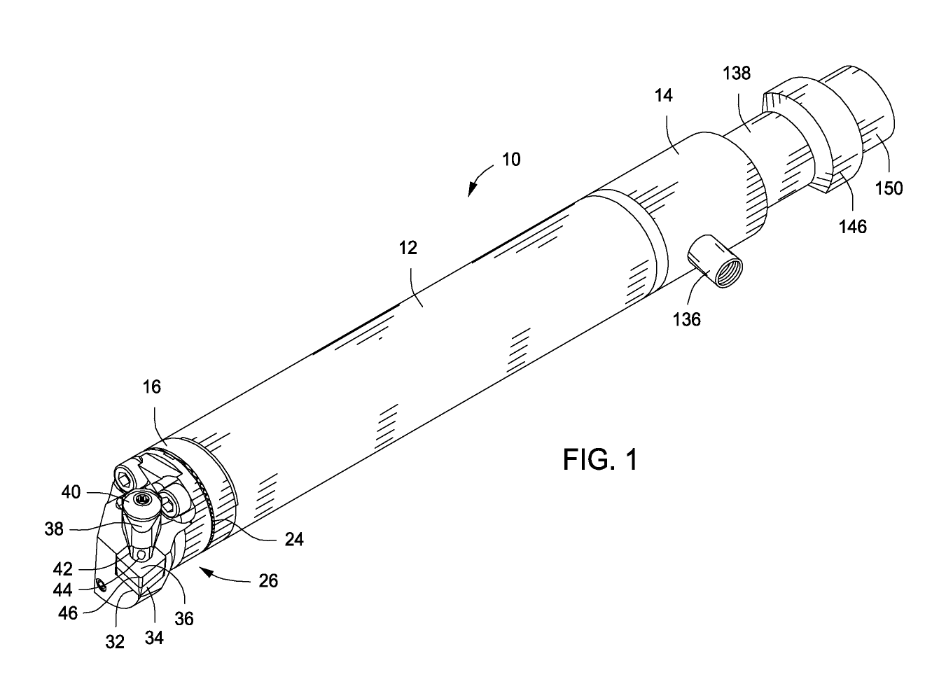

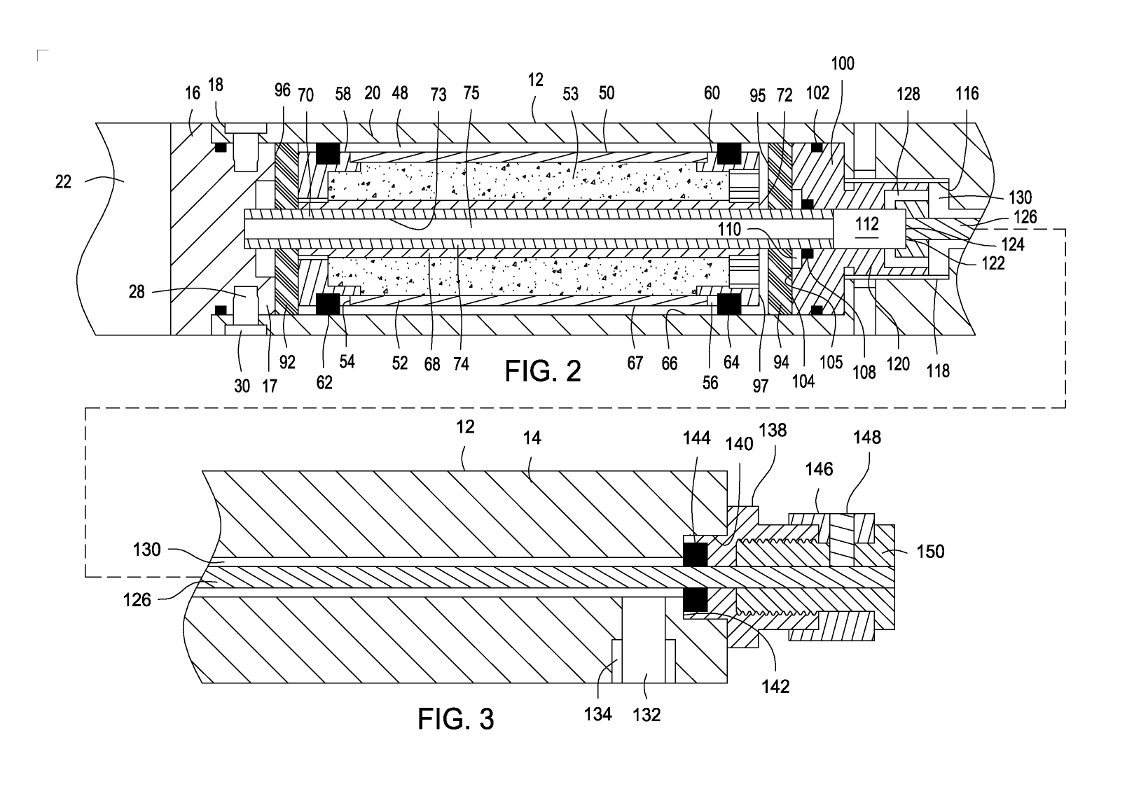

Referring now to the drawings and first to the isometric illustration of FIGS. 1 and 2, an adjustable vibration dampening machine tool holder embodying the principles of the present invention is shown generally at 10 and is in the form of a cutter insert supporting machine tool that is intended to be used to cut cylindrical internal surfaces, internal threads or internal grooving within a work-piece being rotated by a machining system. The machine tool holder 10 incorporates an adjustable or tunable anti-vibration or anti-chatter machining adjustment mechanism that can be manually adjusted to substantially eliminate the resonant frequency of tool holder vibration that is responsible for rough machining of cylindrical surfaces, cutting rough internal threads or grooves within a tubular member. A tool holder embodying the principles of the present invention can also be utilized for machining other types of parts as well.

Though the through-coolant capability of the tool holder is not necessary for anti-vibration tuning or adjustment, the machine tool holder of the present invention preferably provides a coolant fluid handling system to facilitate efficiency of handling and machining. The machine tool holder, as shown in FIG. 2, has an elongate tubular tool body or tool shank 12 having a rear end portion 14 that is adapted to be retained by a chuck of a machining system. The machine tool holder 10 has a tool support collar 16 having an externally threaded projection 17 that is threaded to the internally threaded end 18 of an intermediate tubular section 20. The tool support collar 16 defines a grooved face 22 that is engaged by a corresponding grooved face 24 of a tool support head shown generally at 26 and has a plurality of internally threaded openings 28 that receive threaded fasteners 30, such as set screws, to secure the tool support head in immovable relation with the tool support collar 16 of the elongate tool body 12.

The tool support head 26 defines a cutter insert seat 32 on which is seated a cutter support member 34 that provides for support and stability of a replaceable cutter insert 36. An insert clamp member 38 is retained in assembly with the tool support head 26 by a retainer such as a clamp screw 40. The insert clamp member 38 has a clamping portion 42 that engages the replaceable cutter insert 36 and secures it against movement during machining activity. The insert clamp member 38 also defines a coolant jet port 44 from which a jet of pressurized coolant fluid, passing through-coolant passages of the tool holder, is directed to the cutting edge 46 of the replaceable cutter insert 36 for cooling of the cutting interface of the cutter insert with the work piece being rotated for machining.

As best shown in the longitudinal section view of FIG. 2, the intermediate tubular section 20 of the elongate tool body 12 is of tubular configuration, defining an elongate mass containment chamber 48 within which is located an anti-vibration or vibration dampening mass 50. The anti-vibration mass 50 is preferably composed of a desired volume dense and heavy granular material such as tungsten carbide or any other similar material having a density exceeding the density of steel. Being of loose granular form rather than of solid form the granular mass cannot be supported in centralized relation within the elongate internal chamber 48 in the manner described in applicant's U.S. patent application Ser. No. 14/481,758, filed on Sep. 9, 2014 and entitled “Machine Tool Having Anti-Vibration Tuning Mechanism For Chatter Minimized Machining”. For this reason, the anti-vibration or vibration dampening mass 50 is provided with a means for secure containment of the loose granular mass of dense particulate so as to form a unitary mass structure that is maintained with the mass structure being separated from the machine tool 10.

The anti-vibration or vibration dampening mass structure 50 has a tubular external containment member 52 that defines the outer containment wall of a granular mass containing chamber 53. The tubular external containment member 52 has open axial ends 54 and 56 that are engaged and essentially sealed, respectively, by end flange members 58 and 60. Annular resilient members 62 and 64 are engaged within external annular grooves 63 and 65 of the end flange members 58 and 60 and establish spaced positioning engagement with the internal surface 66 of the intermediate tubular section 20 elongate tubular tool body or tool shank 12.

A tubular internal containment member 68 also has end openings 70 and 72 that are each secured within central openings of the respective end flanges 58 and 60 by threaded engagement, press fitting or by any other suitable means. The tubular internal containment member 68, which is also referred to herein as a connecting tube, serves to retain the end flanges 58 and 60 against displacement from the ends of the outer tubular containment member 52, therefore ensuring that the dense granular material is contained within the. The connecting tube 68 has an inner surface 73 that defines a passage 69 within which is located a tubular coolant flow member 74, as shown in FIG. 2, having a central passage 75 through which coolant fluid flows as the machining system is operated.

Within the flange members 58 and 60, as shown in greater detail in FIGS. 9 and 11, assuming threaded assembly of the flange members 58 and 60 to the tubular internal containment member or connecting tube 68, the end flange members 58 and 60 are provided with threaded central openings 76 and 78, respectively, that receive threaded ends 80 and 82 of the tubular internal containment member or connecting tube 68. When the connecting tube 68 is in threaded engagement with the end flange members, the connecting tube maintains the end flange members securely engaged with the respective open ends of the outer tubular containment member 52 so that the vibration dampening mass 50 is maintained in the form of a unitary structure that can be easily handled without the loss of any of the dense granular material from the chamber 53.

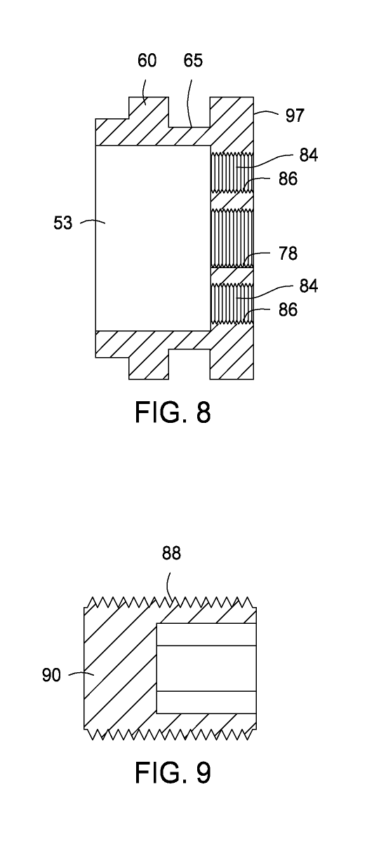

As shown in FIG. 2 and in greater detail in FIGS. 8 and 9, the end flange member 60 defines at least one and preferably a plurality of particulate transfer ports 84 that are internally threaded as shown at 86 and receive the external threads 88 of port closure members 90, which may be in the form of set screws. The port closure members 90 define actuating receptacles such as hex openings so that the port closure members may be rotated by a wrench, such as an Allen wrench, during insertion and removal of the port closure members.

The vibration dampening mass 50 is placed within the elongate mass containment chamber 48 by moving it endwise through the open forward end of the intermediate tubular section 20, with the tool support collar 16 and the resilient partition member having been removed from the tubular section 20. During insertion of the vibration dampening mass 50 the annular resilient member 62 and 64 will be located within their respective annular grooves of the end flange members 58 and 60 and will move into engagement with the inner cylindrical surface 66 of the intermediate tubular section. This linear insertion movement will continue until the vibration dampening mass unit 50 is located substantially at its operative position within the chamber. The annular resilient members are sized to establish relatively firm engagement with the inner cylindrical surface 66, thus centering the vibration dampening mass 50 within the chamber 48 and ensuring that the outer cylindrical surface of the intermediate tubular section 52 is maintained in spaced relation with the inner cylindrical surface 66 of the intermediate tubular section substantially along its entire length. After the vibration dampening mass 50 has been inserted within the chamber 48, the resilient partition member 92 will be installed, with its central opening receiving the tubular coolant fluid flow member 74. The tool support collar 28 will then be installed, being secured to the intermediate tubular section 20 by the threaded fasteners 30.

With the vibration dampening mass 50 removed from the chamber 48 and with the particulate transfer ports 84 open, the granular mass containing chamber 53 may be completely filled with dense granular particulate, such as granular tungsten carbide. During the filling process the vibration dampening mass structure or unit 50 may be vibrated to ensure settling of the granular material within the chamber 53. After the chamber 53 has been filled, the port closure members 90 will then be threaded into the particulate transfer ports 84, thus securing the dense granular material of the vibration dampening mass structure or unit 50 against displacement from the mass containment chamber 53.

As mentioned above, the vibration dampening mass 50 is placed within the chamber 48 of the machine tool with the tool support collar 16 removed from the internally threaded end 18 of the generally cylindrical intermediate tubular section 20 after removal of the threaded fasteners 30. The annular resilient mass support and positioning members 62 and 64 will be located within their respective external annular grooves 63 and 65 and will have mass supporting and centering engagement with the cylindrical internal surface 66 of the chamber 48, thus centering the mass within the chamber, with the external surface 67 of the outer tubular containment member 52 disposed in spaced relation with the internal surface 66 of the intermediate tubular section 20 of the tool housing or shank 12.

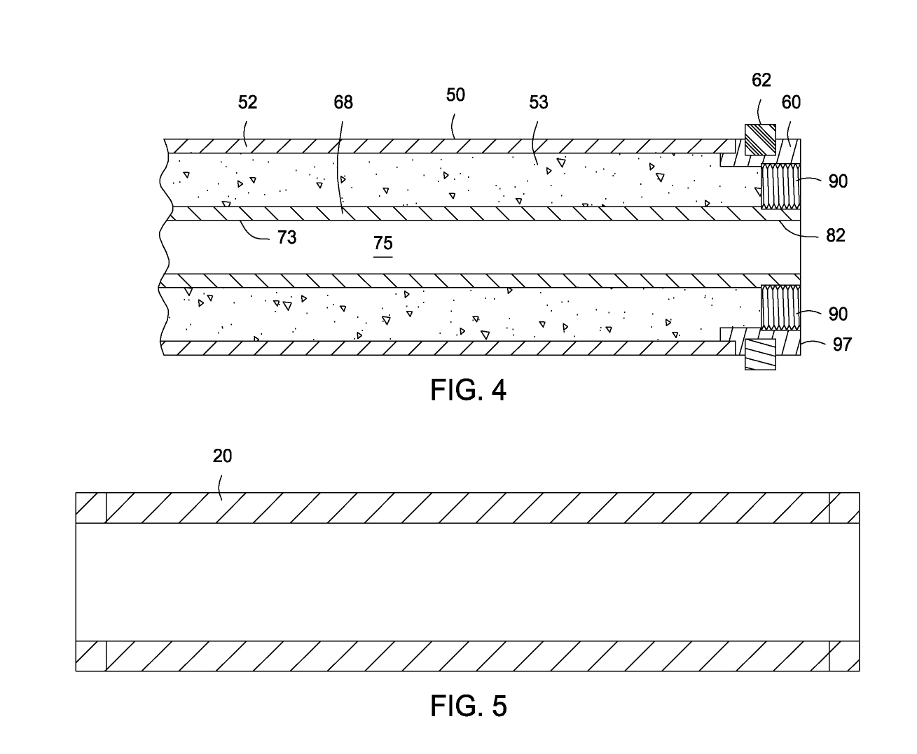

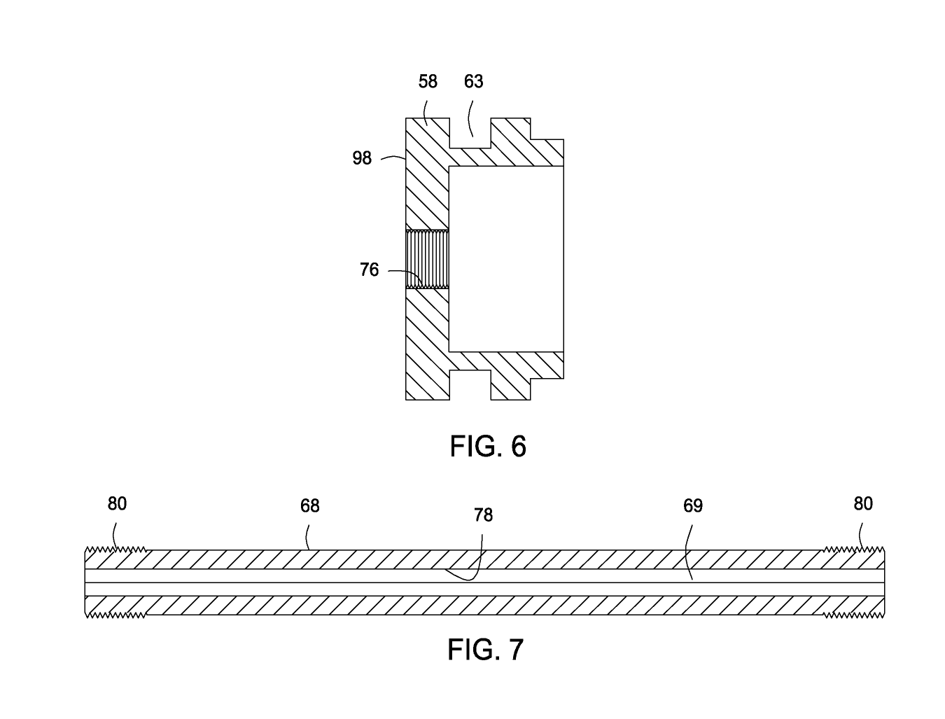

Resilient partition members 92 and 94 having central openings that receive respective end portions of the connecting tube 68 are positioned at respective ends of the vibration dampening mass 50. The resilient partition member 92, which is composed of an elastomer identified as Buna N, or any other suitable resilient or elastomeric material, is disposed in surface to surface engagement with an annular end surface of the tool support collar 16 and is in surface to surface engagement with an axial end surface 98 of the end flange member 58. The resilient partition member 94 defines an annular substantially planar surface 95 that is disposed for force transmitting engagement with the generally planar end surface 97 of the end flange member 60 of FIGS. 2 and 4.

As shown in FIG. 2, a force transmitting tuning piston member 100 is positioned for movement within the rear axial end portion of the mass containment chamber 48. The piston member is sealed with the internal surface 66 of the intermediate tubular section 20 of the tool shank 12 by means of an O-ring sealing member 102 that is contained within an annular external seal groove of the force transmitting member. The resilient partition member 94 is of a dimension that its outer periphery establishes engagement with the inner surface 66 of the intermediate tubular section 20 and has a central opening that fits about the outer cylindrical surface of the tubular coolant flow member 74.

The resilient partition member 94 also defines a planar surface 104 that is disposed for engagement by a planar surface portion 106 of the tuning piston member 100. An annular seal member 108 is retained within an annular seal groove that is defined by the piston member 100 and by a seal retainer member 110 that is secured within a retainer pocket of the piston member. The annular seal member 108 serves to prevent leakage of coolant fluid from a coolant passage 112 into the mass containment chamber 48.

Adjustment of the vibration dampening machine tool is achieved by applying a linear force to the rear end portion of the vibration dampening mass 50 by causing controlled linear movement of the piston member 100 within the mass containment chamber 48. To accomplish this linear piston movement and to prevent rotation of the tuning piston member within the mass containment chamber 48 a chamber 114 is defined within the tool shank 12 and has an internal surface that is formed by a multiplicity of linearly arranged internal guide grooves and ridges 116. The guide grooves and ridges 116 are engaged by corresponding external guide grooves and ridges 118 that define the generally cylindrical external surface area of a rearwardly extending piston projection 120.

The central rear end portion of the piston projection 120 defines a non-circular receptacle 122 within which is received a corresponding non-circular end portion 124 of a piston actuator shaft 126. The non-circular end portion 124 of the actuator shaft fits tightly within the non-circular receptacle, such as by means of tapered friction fit, thus ensuring that the piston member can be moved toward and away from the vibration dampening mass 50 without separation of the shaft end 124 from its receptacle 122. This activity adjusts the position of the vibration dampening mass within its chamber, thus adjusting the vibration frequency of the tool holder. Typically, the tuning piston member is adjusted until the frequency of vibration of the tool holder is under 25 per m/s. At that the tuning piston is locked in place by means of a set screw or other suitable retainer device. A plurality of coolant fluid flow passages 128 are also provided in the piston projection 120 and serve to communicate coolant fluid from a coolant flow passage 130 into the coolant passage 112.

The coolant flow passage 130 extends through the tool shank 12 and is in fluid communication with a coolant fluid supply port 132 that is preferably oriented in transverse relation with the coolant supply passage 130. If desired, the outer portion of the fluid supply port 132 may be internally threaded as shown at 134 to provide for threaded connection of a coolant supply tube or conduit with the machine tool 10. Alternatively, as shown in FIG. 1, a coolant connection fitting 136 may project laterally from the elongate tool shank 12 or the tool mounting end section 14. If desired, the machine tool holder mechanism may not incorporate an internal coolant system and may be provided with an external coolant fluid supply system without departing from the spirit and scope of the present invention. A continuous supply of coolant fluid is necessary to cool and flush the cutting interface of the cutter insert with the work piece being machined, but coolant fluid is not necessary for the vibration dampening feature of the present invention. Thus, the coolant fluid supply may be furnished internally of externally of the tool, without departing from the spirit and scope of the present invention.

The vibration dampening machine tool or tool holder 10 may incorporate any of several adjustment mechanisms that are available for the vibration dampening control. As shown particularly in FIG. 1 and FIG. 3 vibration adjustment may be accomplished by a micrometer type adjustment mechanism or a worm gear type adjustment mechanism as disclosed in applicant's previously identified U.S. patent application Ser. No. 14/481,758, which is incorporated by reference herein for all purposes. A micrometer adjustment mount 138 is threaded into a receptacle 140 defined within the end portion of the tool shank 12 and carries an annular seal member 142 within a seal recess 144. The seal member 142 establishes a seal with the piston actuator shaft 126 to prevent leakage of coolant fluid from the flow passage 130 along the actuator shaft. A micrometer lock member 146 is mounted to the micrometer adjustment mount 138 and carries a set screw 148 that serves to lock the micrometer adjustment mechanism at any position that has been set.

An adjustment member 150 is rotated to move the piston actuator shaft 126 linearly relative to the micrometer lock member 146, thus moving the tuning piston member 100 toward or away from the vibration dampening mass 50 during machining activity until the resonant vibration of the tool has been minimized. Typically the operator of the machining system will adjust the vibration dampening mechanism until the sound of the metal cutting activity becomes as quiet as possible. At this point the set screw 148 is tightened to prevent any further linear movement of the actuator shaft 126, essentially locking the vibration dampening mechanism at the condition that has been set by rotation of the micrometer dampening adjustment mechanism.

If, for any reason, the vibration dampening tool 10 should become unserviceable and must be discarded, with the vibration dampening mass unit 50 removed from the machine tool, the port closure members 90 can be easily unthreaded and removed from the particulate transfer ports, and the fairly expensive dense granular material may simply be poured from the chamber 53 into any suitable container for storage until it is subsequently used in another vibration dampening machine tool.

Operation:

During machining operations, coolant fluid is pumped to the machine tool by the coolant fluid pump of a machining system and through internal coolant passages of the machine tool and through the coolant tube that traverses the center of the vibration dampening mass 50. The pump pressurized coolant fluid is emitted as a jet of coolant from a jet port of a cutter insert clamp member of the cutter support head 26 to the cutting interface of the cutter insert member and the work-piece being machined. This jet of coolant fluid serves to cool the cutting edge of the cutter insert and cool the work piece at the cutting interface. The coolant jet is typically under considerable pressure, thus providing sufficient coolant force to dislodge and wash away the cuttings or chips that are produced by the machining operation.

When machining activity is begun, if the vibration dampening system needs adjustment, the operator of the machining system will typically hear a very loud screeching sound. This sound usually occurs when a relatively long machine tool holder, such as a boring bar or internal threading or grooving tool is being used, because the machine tool holder will typically have considerable length and thus will be flexible. If the work piece being machined is inspected, the surface, thread or groove being machined will typically have a rough or dull appearance due to the resonant frequency vibration of the machine tool.

The machine operator will loosen the set screw 148 or other locking mechanism and will rotate the adjustment member 150 in a direction causing the vibration dampening mass 50 to be moved within the chamber 48 of the tool holder until the screeching sound is quieted. Of course the machining system can be provided with a vibration dampening system having an electronic read-out that will indicate when the vibration dampening is proper for precision machining. Thus, the micrometer type rotary adjustment member is manually rotatable about the longitudinal axis of the tool holder body and causes movement of the tuning piston key rod 126.

The tuning piston key rod actuates the force transmitting tuning piston member 100 and moves the tuning piston against the resilient partition or support member 94. The resilient partition is in supporting and force transmitting engagement with the vibration dampening mass 52 and tends to shift the vibration dampening mass within the mass containment chamber 48 of intermediate tubular section 12 of the tool shank 14. For adjustment of the micrometer type vibration adjustment or tuning mechanism of the tool holder the micrometer adjustment mechanism is manually rotated, typically to the right, causing threaded head portion the hex key rod or shaft 126 to be moved linearly within the passage 130 that also serves as a flow passage for coolant fluid.

Alternatively, the hex key rod or shaft 126 may have a threaded portion that is received by an internally threaded portion of the tuning piston member 100. The hex key rod can be rotated to react with the internal threads of the force transmitting tuning piston member 156, causing the tuning piston member to be driven linearly for vibration dampening adjustment or tuning, thus changing the force being applied by the tuning piston 100 to the resilient dampening ring 94 and from the dampening ring to the vibration dampening mass 50.

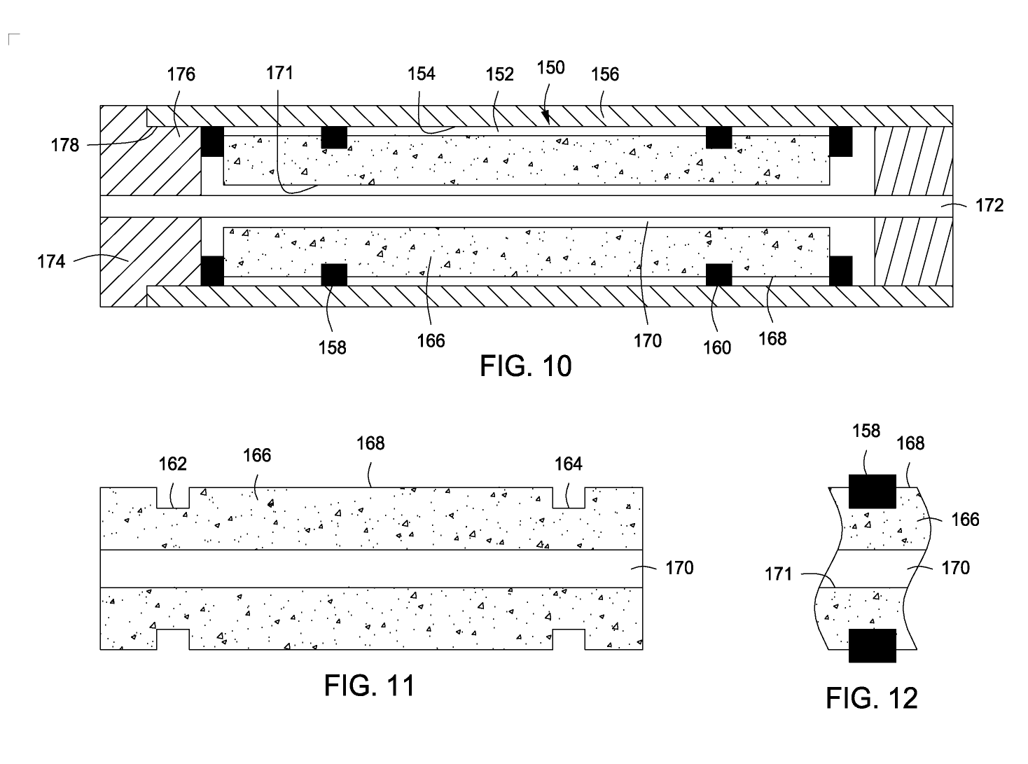

Referring now to FIGS. 10-12, the FIGS. illustrate in simplified form a vibration dampening unit or mass shown generally at 150 which is installed in centered relation within a mass containment chamber 152. The vibration dampening unit or mass 150 is defined by the inner wall surface 154 of a generally cylindrical tubular member 156. Annular O-ring type resilient members 158 and 160 are received by annular grooves 162 and 164 of a vibration dampening body 166 and have engagement with the inner wall surface 154 to maintain the vibration dampening body in centered relation within the mass containment chamber 152, thus maintaining the outer surface 168 of the vibration dampening body in spaced relation with the inner wall surface 154.

The vibration dampening body 166, as shown in FIG. 2, preferably has an external containment membrane or wall which defines the annular grooves 162 and 164 and provides for containment of dense granular material that defines the vibration dampening body 166. This dense granular material can be granulated tungsten carbide or it may be composed of any other granulated material having a density exceeding the density of steel. The dense granular material is typically in a loose, but settled or compacted form within its containment wall structure to ensure that the grains of the granular material do not move about to a substantial extent, especially during machining activity. However, it is envisioned that a quantity of a binder agent, such as a polymer or a filler, such as liquid silicone, oil or water may be employed to displace air from the granular material and to minimize any potential for movement of the grains of the particulate within its container or housing. If a binder agent, such as a polymer, is mixed with the dense granular material it can become hardened, thus ensuring that the grains of the granular material remain stationary within the vibration dampening mass structure 50. In such case, a containment structure for the dense granular material of the vibration dampening body 166 may not be needed.

The vibration dampening body 166 defined a central longitudinal passage 170 within which is positioned a tubular member 172 through which coolant fluid is caused to flow during machining operations. A pair of resilient mass end members, each being composed of a resilient material, such as the elastomer Buna N, are employed to minimize the potential for uncontrolled linear movement of the vibration dampening body 166. An end flange member 174 has a reduced diameter projection 176 that is received within an end opening 178 of the cylindrical tubular member 156.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A vibration dampening tool holder for a machining system, comprising:
a tool body having a supported shank portion for support by a machining system and having a cutter support head and having wall surfaces defining a vibration dampening chamber;
a vibration dampening mass member being located within said vibration dampening chamber and having a containment housing having a particulate chamber therein; and
a quantity of dense particulate material being contained within said particulate chamber and causing said vibration dampening mass member to have sufficient mass to dampen the resonate frequency of vibration of said tool holder during machining activity.

2. The vibration dampening tool holder of claim 1, comprising:
said vibration dampening chamber defining end openings and having end closure flanges and defining an internal wall surface;
resilient dampening members being located in longitudinally spaced relation within said vibration dampening chamber in engagement with said internal wall surface and supporting said vibration dampening mass member in spaced relation with said internal wall surface and in moveable relation within said internal vibration dampening cavity;
a force transmitting member being moveable within said internal tool body and being disposed for application of position adjustment force to said vibration dampening mass member within said internal vibration dampening cavity; and
a vibration frequency adjustment mechanism mounted to said tool body and imparting linear adjustment force to said force transmitting member and adjusting the resonant frequency of said machine tool holder by adjusting the position of said vibration dampening mass member within said vibration dampening chamber.

3. The vibration dampening tool holder of claim 1, comprising:
a vibration frequency adjustment mechanism having a first adjustment member rotatably mounted to said tool body and a second adjustment member translating rotary motion of said first adjustment member to linear movement of said force transmitting member, said vibration frequency adjustment mechanism imparting linear adjustment force to said force transmitting member and said vibration dampening mass member.

4. The vibration dampening tool holder of claim 1, comprising:
said tool body having an internal passage extending from said internal vibration dampening cavity to said supported end portion; and
an elongate adjustment key extending from said first adjustment member through said internal passage and having linear driving vibration frequency adjusting engagement with said force transmitting member, whereby selective rotation of said first adjustment member causing linear dampening adjustment movement of said force transmitting member and said vibration dampening mass member.

5. The vibration dampening tool holder of claim 1, comprising:
said vibration dampening mass member having an outer tubular containment member having ends and having end flange closure members each having closing engagement with an end of said outer tubular containment member; and
an inner tubular containment member being located within said outer tubular containment member and having threaded ends each having threaded engagement with one of said end flange closure members, said inner and outer tubular containment members defining said particulate chamber therebetween, said inner tubular containment member defining a passage through said vibration dampening mass member.

6. The vibration dampening tool holder of claim 5, comprising:
said vibration dampening tool holder having a shank portion being supported and positioned by a machining system and having a tool support head;
a coolant fluid passage being defined within said shank portion and said tool support head; and
a coolant fluid tube extending through said passage of said inner tubular containment member and receiving flowing coolant fluid being pumped by the machining system.

7. The vibration dampening tool holder of claim 6, comprising:
a pair of resilient partition members being located within said elongate mass containment chamber and each having a surface facing an end flange closure member and having a portion of said coolant fluid tube extending therethrough, thus providing for the flow of coolant fluid through said vibration dampening mass member.

8. The vibration dampening tool holder of claim 1, comprising:
a force transmitting piston member being linearly moveable within said vibration dampening chamber of said tool body and having force transmitting relation with said vibration dampening mass member;
a vibration frequency adjustment mechanism being mounted to said tool body;
a piston actuator shaft extending through said tool body and having driven connection with said vibration frequency adjustment mechanism and driving connection with said force transmitting piston member; and
manual adjustment of said vibration frequency adjustment mechanism causing controlled movement of said force transmitting piston member and controlled change of the position of said vibration dampening mass member within said vibration dampening chamber.

9. The vibration dampening tool holder of claim 8, comprising:
said vibration frequency adjustment mechanism having a first adjustment member rotatably mounted to said tool body and a second adjustment member in driven relation with said first adjustment member and translating rotary motion of said first adjustment member to linear movement of said force transmitting member, said vibration frequency adjustment mechanism imparting linear adjustment force to said force transmitting member and said vibration dampening mass member.

10. The vibration dampening tool holder of claim 8, comprising:
said force transmitting member having an internal thread;
said elongate adjustment key having an external thread in threaded engagement with said internal thread; and
upon rotation of said first adjustment member said elongate adjustment key being rotated and said internal and external threads causing linear force adjusting movement of said force transmitting member for controlled absorption of machining induced vibration of said machine tool body.

11. The vibration dampening tool holder of claim 8, comprising:
a coolant flow passage being defined within said tool holder and receiving pressurized coolant fluid from a coolant supply of the machining system and delivering the pressurized coolant fluid to a cutter being supported by said cutter support head; and
a coolant fluid coupling being mounted to said tool body in fluid communication with said coolant flow passage and receiving coolant fluid flow from a coolant supply conductor of the machining system.

12. The vibration dampening tool holder of claim 8, comprising:
a coolant fluid device mounted externally of said machine tool body and having an internal coolant fluid passage and a coolant jet orifice in communication with said internal coolant passage and being oriented to direct a jet of coolant fluid to the cutting interface of a machining insert and a work-piece being machined; and
a coolant supply connector coupling being mounted to said coolant fluid device and having connection with a coolant fluid supply conductor of a machining system.

13. The vibration dampening tool holder of claim 1, comprising:
said vibration dampening mass member having an outer tubular particulate containment member having end openings;
end flange members having closing engagement with said end openings of said outer tubular member; and
an inner tubular particulate containment member being spaced within said outer tubular member the space defining said particulate chamber, said inner tubular particulate containment member securing said end flange members to said end openings of said outer tubular member.

14. The vibration dampening tool holder of claim 13, comprising:
one of said end flange members having a particulate transfer port permitting transfer of dense particulate material into said particulate chamber; and
a port closure member releasably closing said particulate transfer port and maintaining said dense particulate material within said particulate chamber.

15. A vibration dampening tool holder for a machining system, comprising:
An elongate tool body having a shank portion being supported and positioned by a machining system and having a cutter support head and wall structure defining a vibration dampening chamber having an elongate internal surface, said elongate tool body defining an internal passage extending from said internal vibration dampening chamber to said shank portion of said elongate tool body;
a vibration dampening mass member being located centrally within said vibration dampening chamber and defining a particulate containment chamber, said vibration dampening mass member having an outer tubular particulate containment member having end openings;
end flange members having closing engagement with said end openings of said outer tubular member;
an inner tubular particulate containment member being spaced within said outer tubular member the space defining said particulate chamber, said inner tubular particulate containment member securing said end flange members to said end openings of said outer tubular member;
a quantity of dense particulate material being contained within said particulate containment chamber and causing said vibration dampening mass member to have sufficient mass to dampen the resonate frequency of vibration of said tool holder during machining activity.

16. The vibration dampening tool holder of claim 15, comprising:
resilient support and vibration dampening members being located in longitudinally spaced relation within said internal vibration dampening cavity and supporting said vibration dampening mass member for vibration dampening movement within said internal vibration dampening cavity;
a force transmitting member being located within said internal tool body and having force transmitting relation with said vibration dampening mass member within said internal vibration dampening cavity; and
a vibration frequency adjustment mechanism having a first adjustment member rotatably mounted to said tool body and a second adjustment member in driven relation with said first adjustment member and translating rotary motion of said first adjustment member to linear movement of said force transmitting member, said vibration frequency adjustment mechanism imparting linear adjustment force to said force transmitting member and said vibration dampening mass member.

17. The vibration dampening tool holder of claim 15, comprising:
said tool body having an internal passage extending from said internal vibration dampening cavity through said shank portion;
an elongate adjustment key extending from said first adjustment member through said internal passage and having linear driving vibration frequency adjusting engagement with said force transmitting member, whereby selective rotation of said first adjustment member causing linear dampening adjustment movement of said force transmitting member and said vibration dampening mass member;
said force transmitting member having an internal thread;
said elongate adjustment key having an external thread in threaded engagement with said internal thread; and
upon rotation of said first adjustment member said elongate adjustment key being rotated and said internal and external threads causing linear force adjusting movement of said force transmitting member for controlled absorption of machining induced vibration of said machine tool body.

18. The adjustable vibration dampening tool holder of claim 15, comprising:
a coolant fluid device mounted externally of said machine tool body and having an internal coolant fluid passage and a coolant jet orifice in communication with said internal coolant passage and being oriented to direct a jet of coolant fluid to the cutting interface of a machining insert and a work-piece being machined; and
a coolant supply connector coupling being mounted to said coolant fluid device and having connection with a coolant fluid supply conductor of a machining system.

19. The vibration dampening tool holder of claim 15, comprising:
said vibration dampening mass member having an outer tubular particulate containment member having end openings;
end flange members having closing engagement with said end openings of said outer tubular member;
an inner tubular particulate containment member being spaced within said outer tubular member the space defining said particulate chamber, said inner tubular particulate containment member securing said end flange members to said end openings of said outer tubular member;
one of said end flange members having a particulate transfer port permitting transfer of dense particulate material into said particulate chamber; and
a port closure member releasably closing said particulate transfer port and maintaining said dense particulate material within said particulate chamber.
